(19) United States
(12) Patent Application Publication
(10) Pub. No.: US 2007/0047255 A1
(43) Pub. Date: Mar. 1, 2007

(54) BACKLIGHT MODULE AND LIQUID CRYSTAL DISPLAY MODULE

(76) Inventor: Yun-Shih Wang, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/162,155

(22) Filed: Aug. 31, 2005

(51) Int. Cl. F21V 7/04

(52) U.S. Cl. 362/609

(57) ABSTRACT

A liquid crystal display module comprising a backlight module and a liquid crystal display panel is provided. The backlight module comprises a light-guide plate, a reflector and a light source. The light-guide plate comprises a first surface, and the first surface comprises a first position part. The reflector having a connection surface is arranged at one side of the light-guide plate, and the connection surface has a second position part corresponding to the first position part. The first position part is lodged in the second position part. Besides, the light source is arranged between the light-guide plate and the reflector, and the light source may be a cold cathode fluorescent lamp or a light emitting diode. Because the light-guide plate and the reflector are firmly wedged, the liquid crystal display module can maintain good display quality.

### BACKGROUND OF THE INVENTION

1. Field of the Invention

The present invention generally relates to a backlight module and a liquid crystal display module. More particularly, the present invention relates to the backlight module having a fixed light source and the liquid crystal display module thereof.

2. Description of Related Art

With recent advancement in modern video technology, the tendency of the video device is towards light weight, big size and thin panel. The flat panel display fabricated by the optoelectronic technology and semiconductor process such as the liquid crystal display (LCD), the organic electroluminescent device (OLED) or the plasma display panel (PDP) has become the mainstream of the display device. Most of the cell phone, the digital camera, the digital video camera, the notebook and the desk-top computer utilize the LCD panel as the display screen. The LCD panel doesn't emit light itself so a backlight module is arranged below the LCD panel, to provide the surface light source for the LCD panel. Then, the LCD panel can display image.

FIG. 1 is a schematic drawing according to a conventional backlight module. As shown in FIG. 1, the backlight module 10 comprises a light-guide plate 11, a reflector 12 and a light source 13. The reflector 12 is arranged at one side of the light-guide plate 11. The light source 13 is arranged between the reflector 12 and the light-guide plate 11 to form the backlight module 10. But the light-guide plate 11 of the backlight module 10 would tilt because the error produced during the fabrication process or the external impact after fabrication. The tilt of the light-guide plate 11 would affect the light source 13 of the backlight module 10 and further affect the display quality of the LCD module.

### SUMMARY OF THE INVENTION

Accordingly, the present invention is directed to a backlight module having a fixed light source.

The present invention is also directed to providing a liquid crystal display module having good display quality.

According to an embodiment of the present invention, a backlight module having at least a light-guide plate, a reflector and a light source is provided. The light-guide plate has a first surface, and the first surface has a first position part. The reflector is arranged at one side of the light-guide plate and has a connection surface. A second position part formed on the connection surface is corresponding to the first position part, and the first position part is lodged in the second position part. Besides, the light source is arranged between the light-guide plate and the reflector. The light source may be a cold cathode fluorescent lamp or a light emitting diode.

According to an embodiment of the present invention, the first position part may be a protrusion, and the shape and the number of the second position part are corresponding to those of the first position part. So, the second position part may be a concave or an opening. In another embodiment of the present invention, the first position part may be a concave, and the second position part may be a protrusion.

According to an embodiment of the present invention, the light-guide plate comprises a second surface having a third position part is opposite to the first surface. A fourth position part corresponding to the third position part is formed on the connection surface, and the third position part is lodged in the fourth position part. It means that if the first position part is a protrusion and the second position part is a concave or an opening, the third position part would be a protrusion and the fourth position part would be a concave or an opening. Alternatively, if the first position part is a protrusion and the second position part is a concave or an opening, the third position part would be a concave and the fourth position part would be a protrusion.

According to an embodiment of the present invention, the light-guide plate comprises a second surface having a third position part is opposite to the first surface. A fourth position part corresponding to the third position part is formed on the connection surface, and the third position part is lodged in the fourth position part. It means that if the first position part is a concave and the second position part is a protrusion, the third position part would be a protrusion and the fourth position part would be a concave or an opening. Alternatively, if the first position part is a concave and the second position part is a protrusion, the third position part would be a concave and the fourth position part would be a protrusion.

According to another embodiment of the present invention, a liquid crystal display module having a backlight module and a liquid crystal display panel is provided.

The backlight module comprises a light-guide plate, a reflector and a light source. The light-guide plate has a first surface, and the first surface has a first position part. The reflector is arranged at one side of the light-guide plate and has a connection surface. A second position part formed on the connection surface is corresponding to the first position part, and the first position part is lodged in the second position part. Besides, the light source is arranged between the light-guide plate and the reflector. The light source may be a cold cathode fluorescent lamp or a light emitting diode.

According to an embodiment of the present invention, the first position part may be a protrusion, and the second position part may be a concave or an opening. In another embodiment of the present invention, the first position part may be a concave, and the second position part may be a protrusion.

According to an embodiment of the present invention, the light-guide plate comprises a second surface having a third position part is opposite to the first surface. A fourth position part formed on the connection surface is corresponding to the third position part, and the third position part is lodged in the fourth position part. It means that if the first position part is a protrusion and the second position part is a concave or an opening, the third position part would be a protrusion and the fourth position part would be a concave or an opening. Alternatively, if the first position part is a protrusion and the second position part is a concave or an opening, the third position part would be a concave and the fourth position part would be a protrusion.

According to an embodiment of the present invention, the light-guide plate comprises a second surface having a third position part is opposite to the first surface. A fourth position part formed on the connection surface is corresponding to the third position part, and the third position part is lodged in the fourth position part. It means that if the first position part is a concave and the second position part is a protrusion, the third position part would be a protrusion and the fourth position part would be a concave or an opening. Alternatively, if the first position part is a concave and the second position part is a protrusion, the third position part would be a concave and the fourth position part would be a protrusion.

According to an embodiment of the present invention, the liquid crystal display module further comprises an optical film arranged between the backlight module and the liquid crystal display panel. The optical film may be a prism, a brightness enhanced film or a diffuser.

In summary, the position parts formed on the reflector and the light-guiding plate of the present invention may cooperate with each other in order to make the light-guiding plate firmly fixed on the reflector. So, the light-guiding plate would not easily tilt or displace due to external force, and the light source is firmly fixed. Then, the liquid crystal display module can maintain good display quality.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic drawing according to a conventional backlight module.

FIG. 2 is a schematic drawing showing a backlight module according to the first embodiment of the present invention.

FIGS. 3 and 4 are schematic drawings showing a backlight module according to another embodiment of the present invention after the light-guiding plate and the reflector are configured.

FIG. 5 is a schematic drawing according to the second embodiment of the present invention after the light-guiding plate and the reflector are configured.

FIG. 6 is a schematic drawing according to the third embodiment of the present invention after the light-guiding plate and the reflector are configured.

FIG. 7 is a schematic drawing according to the fourth embodiment of the present invention after the light-guiding plate and the reflector are configured.

FIGS. 8 to 13 are schematic drawings showing different types of position parts formed on the light-guiding plate and the reflector according to another embodiment of the present invention.

FIG. 14 is a schematic drawing showing a liquid crystal display module according to an embodiment of the present invention.

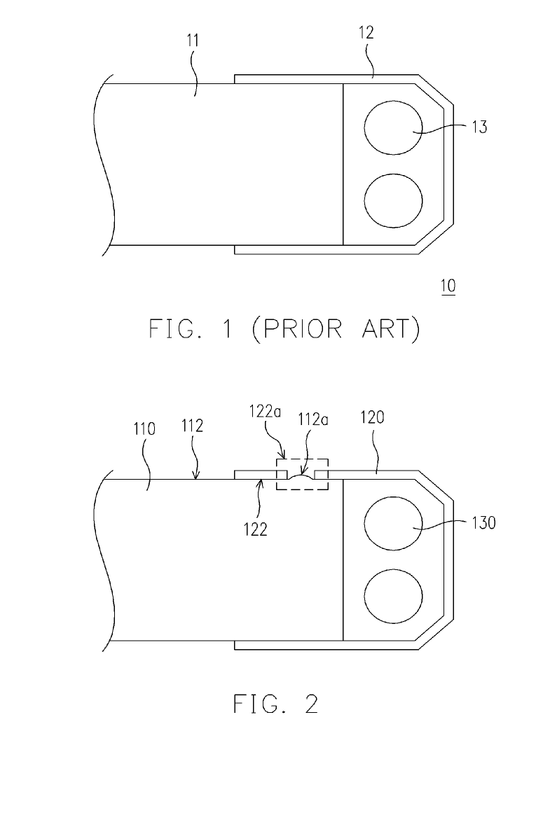

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

### First Embodiment

FIG. 2 is a schematic drawing showing a backlight module according to the first embodiment of the present invention. As shown in FIG. 2, the backlight module 100 comprises a light-guide plate 110, a reflector 120 and a light source 130. The reflector 120 is arranged at one side of the light-guide plate 110, and the light source 130 is arranged between the light-guide plate 110 and the reflector 120. The light source 130 may be a cold cathode fluorescent lamp or a light emitting diode. It should be noted that the invention utilizes the matched position parts formed on the light-guide plate 110 and the reflector 120 to make the light-guide plate 110 fixed on the reflector 120.

Please refer to FIG. 2, the light-guide plate 110 has a surface 112, and the surface 112 has a position part 112a. In this embodiment, the position part 112a may be a protrusion. Besides, the reflector 120 has a connection surface 122 connected with the light-guide plate 110, and the connection surface 122 has a position part 122a corresponding to the position part 112a of the light-guide plate 110. In this embodiment, the position part 122a may be an opening. So, when the reflector 120 is configured on the light-guide plate 110, the position part 112a would be wedged in the position part 122a, and the light-guide plate 110 is fixed on the reflector 120.

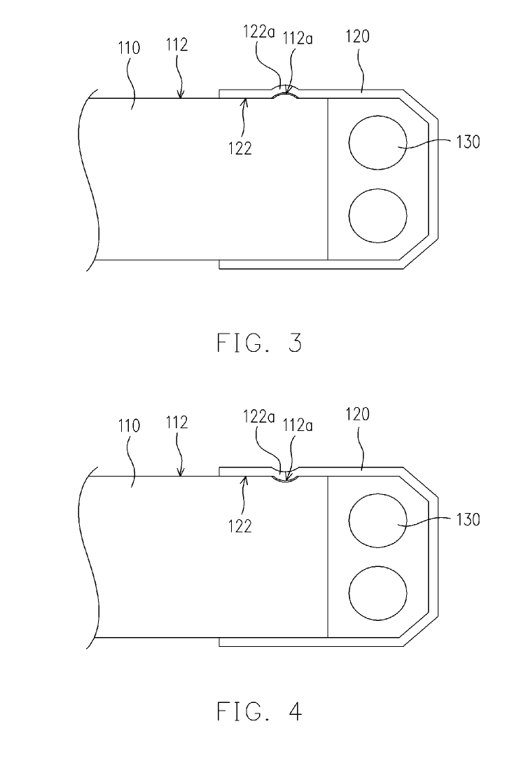

Besides, the position parts 112a and 122a are not limited to the protrusion and the opening, respectively. FIGS. 3 and 4 are schematic drawings showing a backlight module according to another embodiment of the present invention after the light-guiding plate and the reflector are configured. As shown in FIG. 3, the position part 112a of the light-guide plate 110 may be a protrusion and the position part 122a of the reflector 120 may be a concave. Besides, as shown in FIG. 4, the position part 112a of the light-guide plate 110 may be a concave and the position part 122a of the reflector 120 may be a protrusion.

In the above mentioned embodiment, the position structures formed on the connection surfaces of the light-guide plate 110 and the reflector 120 like the protrusion and the corresponding concave or the opening can make the light-guide plate 110 firmly fixed on the reflector 120. The invention may further comprises a plurality of position structures formed on the opposite two sides of the light-guide plate 110 and the reflector 120 except on only one side of them, to make the light-guide plate 110 strongly fixed on the reflector 120.

### Second Embodiment

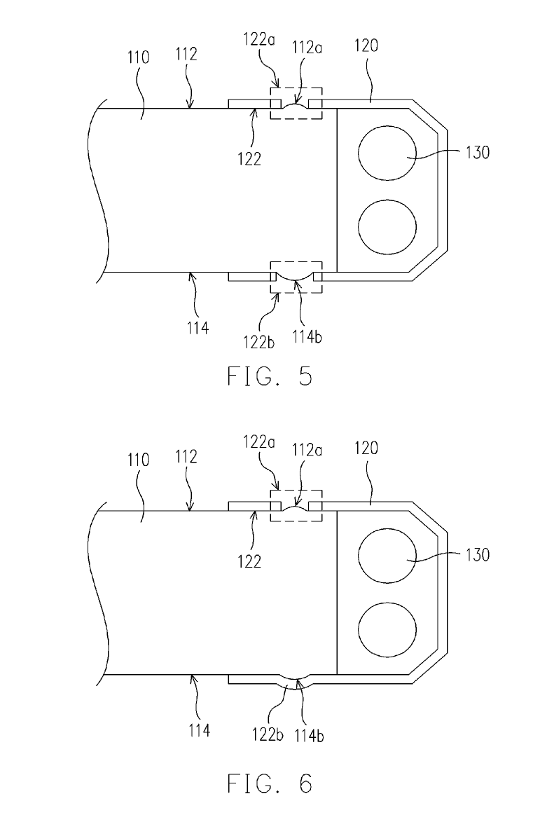

FIG. 5 is a schematic drawing according to the second embodiment of the present invention. As shown in FIG. 5, the light-guide plate 110 comprises two opposite surfaces 112 and 114. The surface 112 has a position part 112a, and the surface 114 has a position part 114b. In this embodiment, the position parts 112a and 114b are protrusions.

The connection surface 122 of the reflector 120 has position parts 122a and 122b corresponding to the position parts 112a and 114b of the light-guide plate 110. In this embodiment, the position parts 122a and 122b are openings. The position parts 112a and 114b of the light-guide plate 110 are wedged in the position parts 122a and 122b of the reflector 120, to make the light-guide plate 110 strongly fixed on the reflector 120.

It should be noted that the difference between the first and the second embodiments is the position part 112a only formed on one side of the light-guide plate 110. If the position part 112a is a protrusion, the position part 122a like an opening or a concave corresponding to the position part 112a would be formed on the reflector 120. In the embodiment, the position parts 112a and 114b are formed on two sides of the light-guide plate 110. If the position parts 122a and 122b are the openings, the position parts 112a and 114b would be protrusions corresponding to the openings.

Equally, the invention may further have different types of position parts formed on the light-guide plate and the reflector. The description of the different position parts will be illustrated in the following.

FIG. 6 is a schematic drawing according to another embodiment of the present invention. In this embodiment, the position parts 112a and 114b of the light-guide plate 110 are protrusions, the position part 122a corresponding to the position parts 112a and formed on the connection surface 122 of the reflector 120 is an opening and the position part 122b corresponding to the position part 114b is a concave.

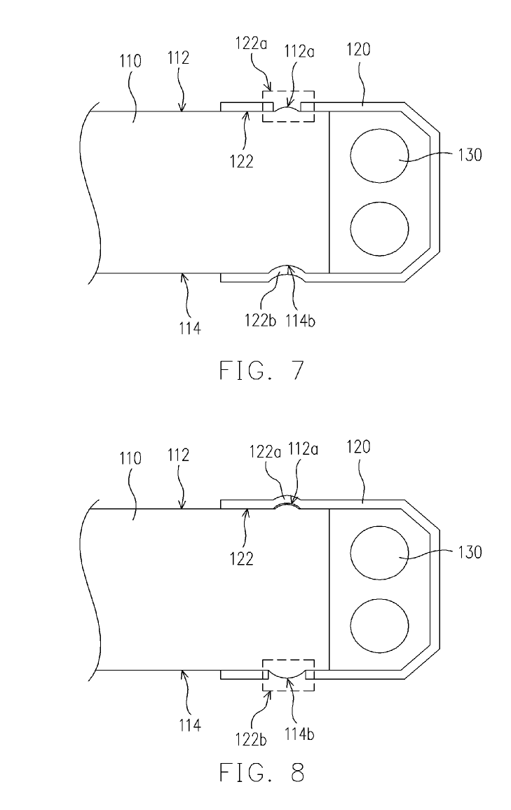

FIG. 7 is a schematic drawing according to another embodiment of the present invention. In this embodiment, the position parts 112a and 114b of the light-guide plate 110 are the protrusion and the concave respectively, the position part 122a corresponding to the position parts 112a and formed on the connection surface 122 of the reflector 120 is an opening and the position part 122b corresponding to the position part 114b is a protrusion.

From the above embodiments, the position parts 112a and 114b of the light-guide plate 110 and the position part 122a and 122b of the reflector 120 may have different types and combinations. If the position part 112a of the light-guide plate 110 is a protrusion, the corresponding position part 122a may be an opening or a concave. Besides, if the position part 112a of the light-guide plate 110 is a concave, the corresponding position part 122a may be a protrusion. Similarly, the position part 114b of the light-guide plate 110 and the position part 122b of the reflector 120 may cooperate as the above description.

Except the foregoing embodiments, the invention further comprises the following embodiments.

As shown in FIG. 8, the position parts 112a and 114b of the light-guide plate 110 are all protrusions, and the position parts 122a and 122b of the reflector 120 are a concave and an opening respectively. The position part 112a is corresponding to the position part 122a, and the position part 114b is corresponding to the position part 122b.

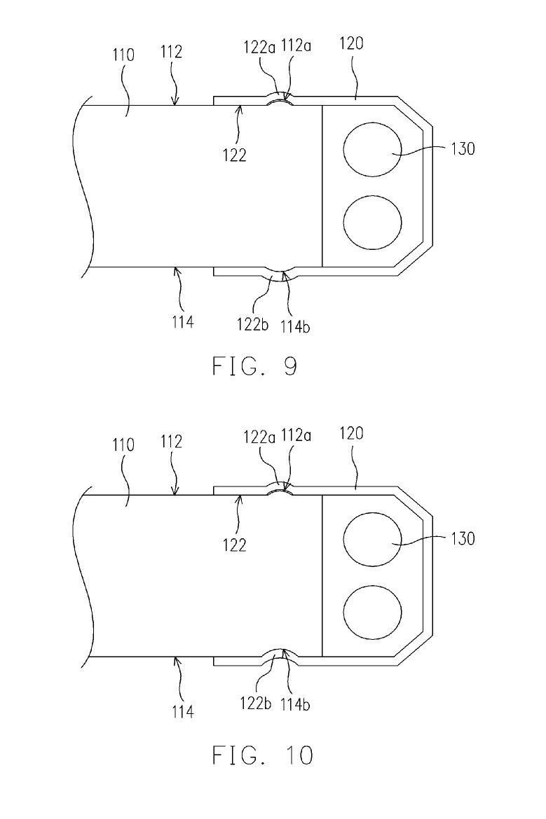

As shown in FIG. 9, the position parts 112a and 114b of the light-guide plate 110 are all protrusions, and the position parts 122a and 122b of the reflector 120 are all concaves. The position part 112a is corresponding to the position part 122a, and the position part 114b is corresponding to the position part 122b.

As shown in FIG. 10, the position part 112a and 114b of the light-guide plate 110 are a protrusion and a concave respectively. The position parts 122a and 122b of the reflector 120 are a concave and a protrusion respectively. The position part 112a is corresponding to the position part 122a, and the position part 114b is corresponding to the position part 122b.

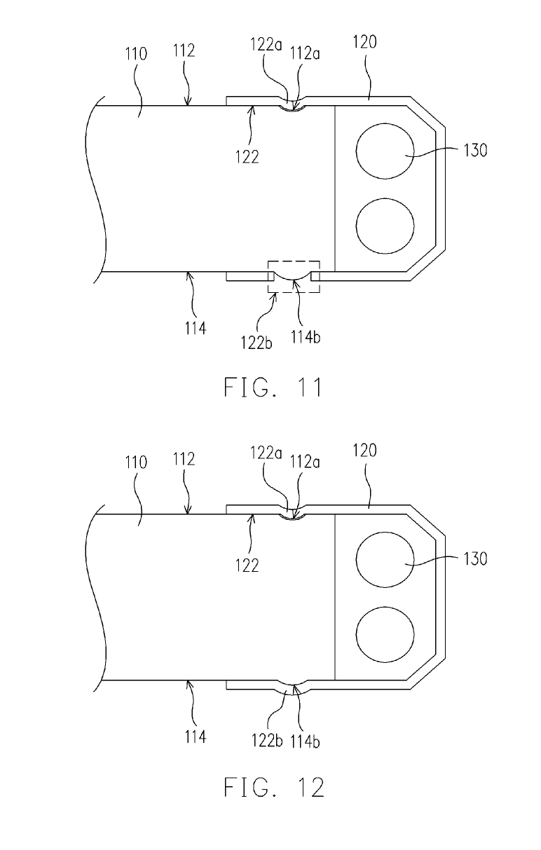

As shown in FIG. 11, the position part 112a and 114b of the light-guide plate 110 are a concave and a protrusion respectively. The position parts 122a and 122b of the reflector 120 are a protrusion and an opening respectively. The position part 112a is corresponding to the position part 122a, and the position part 114b is corresponding to the position part 122b.

As shown in FIG. 12, the position part 112a and 114b of the light-guide plate 110 are a concave and a protrusion respectively. The position parts 122a and 122b of the reflector 120 are a protrusion and a concave respectively. The position part 112a is corresponding to the position part 122a, and the position part 114b is corresponding to the position part 122b.

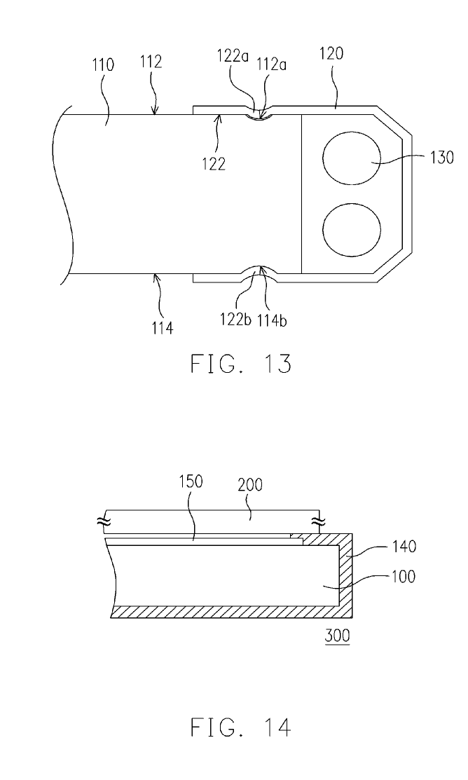

As shown in FIG. 13, the position part 112a and 114b of the light-guide plate 110 are all concaves. The position parts 122a and 122b of the reflector 120 are all protrusions. The position part 112a is corresponding to the position part 122a, and the position part 114b is corresponding to the position part 122b.

It should be noted that the types of the position parts formed on the light-guide plate and the reflector of the present invention are not limited to the above mentioned openings, concaves and the protrusions, and the number of the position parts is not limited, too. The light-guide plates fixed on the reflectors by different types and number of the position parts would fall within the scope of the invention.

FIG. 14 is a schematic drawing showing a liquid crystal display module according to an embodiment of the present invention. As shown in FIG. 14, the liquid crystal display module 300 comprises an above mentioned backlight module 100 and a liquid crystal display panel 200 arranged on the backlight module 100. The components and positions of them within the backlight module 100 are illustrated above, so it is not repeated herein. The liquid crystal display module 300 utilizes a frame 140 to wrap the backlight module 100. Besides, an optical film 150 is arranged between the liquid crystal display panel 200 and the backlight module 100. The optical film 150 may be a prism, a brightness enhanced film or a diffuser.

In summary, whatever the types of the position parts may be, the structure and the position of the position parts formed on the light-guide plate and the reflector should match up. For example, if the position part of the light-guide plate is an opening or a concave, the position part of the reflector would be a protrusion. Alternatively, if the position part of the light-guide plate is a protrusion, the position parts of the reflector would be an opening or a concave. This will make the position part of the light-guide plate be lodged in that of the reflector, and also make the light-guide plate firmly fixed on the reflector. So, even if the light-guide plate is impacted by external force, the light-guide plate would not tilt or displace. It means that even if the backlight module or the liquid crystal display module is impacted by external force, the light-guide plate would be still fixed on the reflector. So, the backlight module has a more fixed light source, and the display quality of the liquid crystal display module is better.

It will be apparent to those skilled in the art that various modifications and variations may be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A backlight module, comprising:
a light-guide plate having a first surface, and the first surface having a first position part;
a reflector arranged at one side of the light-guide plate and having a connection surface, wherein a second position part formed on the connection surface is corresponding to the first position part, and the first position part is lodged in the second position part; and
a light source arranged between the light-guide plate and the reflector.

2. The backlight module according to claim 1, wherein the first position part comprises a protrusion and the second position part comprises a concave or an opening.

3. The backlight module according to claim 2, wherein the light-guide plate has a second surface opposite to the first surface, the second surface has a third position part, a fourth position part corresponding to the third position part is formed on the connection surface, and the third position part is lodged in the fourth position part.

4. The backlight module according to claim 3, wherein the third position part comprises a protrusion and the fourth position part comprises a concave or an opening.

5. The backlight module according to claim 3, wherein the third position part comprises a concave and the fourth position part comprises a protrusion.

6. The backlight module according to claim 1, wherein the first position part comprises a concave and the second position part comprises a protrusion.

7. The backlight module according to claim 6, wherein the light-guide plate has a second surface opposite to the first surface, the second surface has a third position part, a fourth position part formed on the connection surface is corresponding to the third position part, and the third position part is lodged in the fourth position part.

8. The backlight module according to claim 7, wherein the third position part comprises a protrusion and the fourth position part comprises a concave or an opening.

9. The backlight module according to claim 7, wherein the third position part comprises a concave and the fourth position part comprises a protrusion.

10. The backlight module according to claim 1, wherein the light source comprises a cold cathode fluorescent lamp or a light emitting diode.

11. A liquid crystal display module, comprising:
a backlight module, comprising:
a light-guide plate having a first surface, and the first surface having a first position part;
a reflector arranged at one side of the light-guide plate and having a connection surface, wherein a second position part formed on the connection surface is corresponding to the first position part, and the first position part is lodged in the second position part; and
a light source arranged between the light-guide plate and the reflector; and
a liquid crystal display panel arranged on the backlight module.

12. The backlight module according to claim 11, wherein the first position part comprises a protrusion and the second position part comprises a concave or an opening.

13. The backlight module according to claim 12, wherein the light-guide plate has a second surface opposite to the first surface, the second surface has a third position part, a fourth position part formed on the connection surface is corresponding to the third position part, and the third position part is lodged in the fourth position part.

14. The backlight module according to claim 13, wherein the third position part comprises a protrusion and the fourth position part comprises a concave or an opening.

15. The backlight module according to claim 13, wherein the third position part comprises a concave and the fourth position part comprises a protrusion.

16. The backlight module according to claim 11, wherein the first position part comprises a concave and the second position part comprises a protrusion.

17. The backlight module according to claim 16, wherein the light-guide plate has a second surface opposite to the first surface, the second surface has a third position part, a fourth position part formed on the connection surface is corresponding to the third position part, and the third position part is lodged in the fourth position part.

18. The backlight module according to claim 17, wherein the third position part comprises a protrusion and the fourth position part comprises a concave or an opening.

19. The backlight module according to claim 17, wherein the third position part comprises a concave and the fourth position part comprises a protrusion.

20. The backlight module according to claim 11, further comprises an optical film arranged between the backlight module and the liquid crystal display panel.
